(19) United States
(12) Patent Application Publication
(10) Pub. No.: US 2007/0035375 A1
(43) Pub. Date: Feb. 15, 2007

(54) Structure of high voltage stabilizer

(76) Inventor: Sen-Tai Yang, San Hsia Town (TW)

Correspondence Address: TROXELL LAW OFFICE PLLC, SUITE 1404, 5205 LEESBURG PIKE, FALLS CHURCH, VA, 22041, US

(21) Appl. No.: 11/374,961

(22) Filed: Mar. 15, 2006

(30) Foreign Application Priority Data
Aug. 12, 2005 (TW) 94213818

(51) Int. Cl. H01F 27/24

(52) U.S. Cl. 336/212

(57) ABSTRACT

An improved structure of high voltage stabilizer mainly includes a primary core, a secondary core, a primary coil, and a secondary coil. The primary core further includes a first side and a second side where the second side is connected, in perpendicular direction, to an end of the first side. A first salient portion and a second salient portion being having the same height and being both relatively higher than that of the second side are provided on the inner side of the first side and are near and positioned outward from the second side. The primary coil and the secondary coil wind respectively around the first salient portion and the second salient portion of the primary core. What is more, the secondary core appearing a plate in shape can cover upon the top surfaces of the first salient portion and the second salient portion respectively, and has an end portion extending above the top of the second side of the primary core to form a gap between them.

### BACKGROUND OF THE INVENTION

1. Field of the Invention

The invention relates to an improved structure of high voltage stabilizer, and more particularly, to an improved structure of high voltage stabilizer that is low in cost and can keep stable value of output current through adjustment.

2. Description of the Prior Art

As shown in FIG. 1 through FIG. 3, the conventional transformer structure for electrically discharged light tube includes an E-shaped core (5), a T-shaped core (6), a primary coil (7), and a secondary coil (8). The E-shaped core (5) is equipped with an extended end salient portion (51) at the two ends thereof as well as a relatively shorter and extended middle salient portion (52). The T-shaped core (6) is equipped with an extended middle salient portion (61) too. The primary coil (7) and the secondary coil (8) wind respectively around the two end salient portions (51) of the E-shaped core (5). By the use of the T-shaped core (6) to cover on the open side of the E-shaped core (5), the two end salient portions (51) will contact the two end portions of the T-shaped core (6). In this way, the middle salient portion (52) of the E-shaped core (5) will not contact with the middle salient portion (61) of the T-shaped core (6) but leave a gap (62) between them. Once the power is on for the primary coil (7) (or the secondary coil (8)), a magnetic flux circuit C is generated between the E-shaped core (5) and T-shaped core (6) making the secondary coil (8) (or primary coil (7)) generate a rated induction voltage. In the meantime, an appropriate magnetic leakage is formed at the gap (62) to maintain stable output voltage.

However, the output voltage and current of this structural type of transformer is subject to generate variation following the increase of the loading. Since there is no magnetic flux passing through the gap (62), it is not possible to make use of the size of the gap (62) to control and adjust the output voltage. Meanwhile, to obtain stable output current for the most part will depend upon the adjustment through the using an electronic stabilizing circuit affixed thereon. That the electronic stabilizing circuit not only increasing the complexity of its structure but also raising the cost of the product is not advantageous to compete in the products' market.

### SUMMARY OF THE INVENTION

In light of the above-mentioned disadvantages of the prior arts, the invention aims to ameliorate at least some of the disadvantages of the prior art or to provide a useful alternative.

The primary objective of the invention is to form a magnetic flux circuit between the primary core and secondary core at the first salient portion and second salient portion as well as to form an anti-magnetic flux circuit between the primary core and the secondary core at the second salient portion and the second side. By changing the size of the gap between the secondary core and the second side of the primary core, one can adjust output current at the end of the relatively higher voltage and form an adjustable and stable output current. In this way, the invention being capable of omitting the conventional electronic stabilized circuit to lower the cost effectively has the advantages of being capable of adjusting to vary the output current, being simple in core structure, as well as maintaining in a status of optimum power supply.

The secondary objective of the invention is to increase the rated value of output current by making use of a plurality of unit structures of the primary core and secondary core to combine them in parallel.

To achieve the above-mentioned objectives, the invention provides an improved structure of high voltage stabilizer that includes a primary core, a secondary core, a primary coil, and a secondary coil. The primary core further includes a first side and a second side where the second side is connected, in perpendicular direction, to an end of the first side. A first salient portion and a second salient portion having the same height and both being relatively higher than that of the second side are provided on the inner side of the first side and are near and positioned outward from the second side. The primary coil and the secondary coil wind respectively around the first salient portion and the second salient portion of the primary core. What is more, the secondary core appearing a plate in shape can cover upon the top surfaces of the first salient portion and the second salient portion respectively, and has an end portion extending above the top of the second side of the primary core (1) to form a gap between them.

The accomplishment of this and other objectives of the invention will become apparent from the following description and its accompanying drawings of which:

### BRIEF DESCRIPTION OF THE DRAWINGS

FIG. 1 is an exploded view of the conventional transformer structure for electrically discharged light tube;

FIG. 2 is an isometric view showing the outward appearance of the assembled transformer structure for electrically discharged light tube of the prior art;

FIG. 3 is a schematic cross-sectional view of the magnetic flux circuit for the electrically discharged light tube of the transformer structure of the prior art;

FIG. 4 is an exploded view of the core structure of the prior art;

FIG. 5 is an isometric view showing the outward appearance of the assembled core structure of the invention;

FIG. 6 is a schematic cross-sectional view of the magnetic flux circuit of the core structure of the invention;

FIG. 7 is a preferred derived embodiment of the invention.

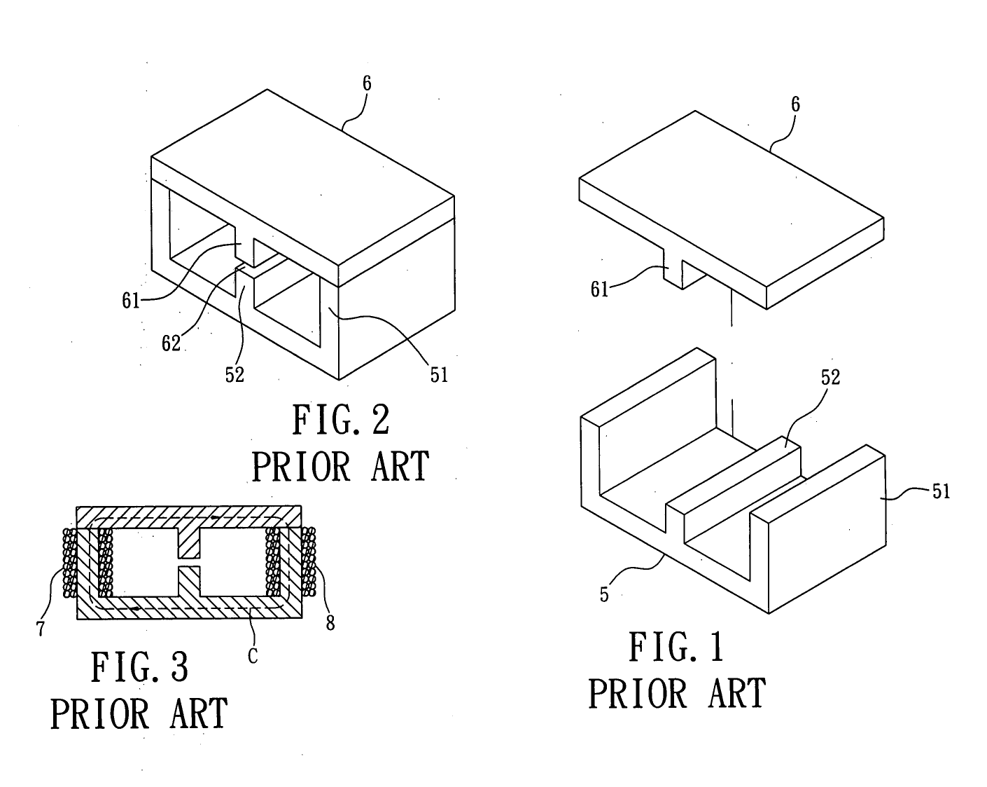

### DETAILED DESCRIPTION OF THE PREFERRED EMBODIMENT

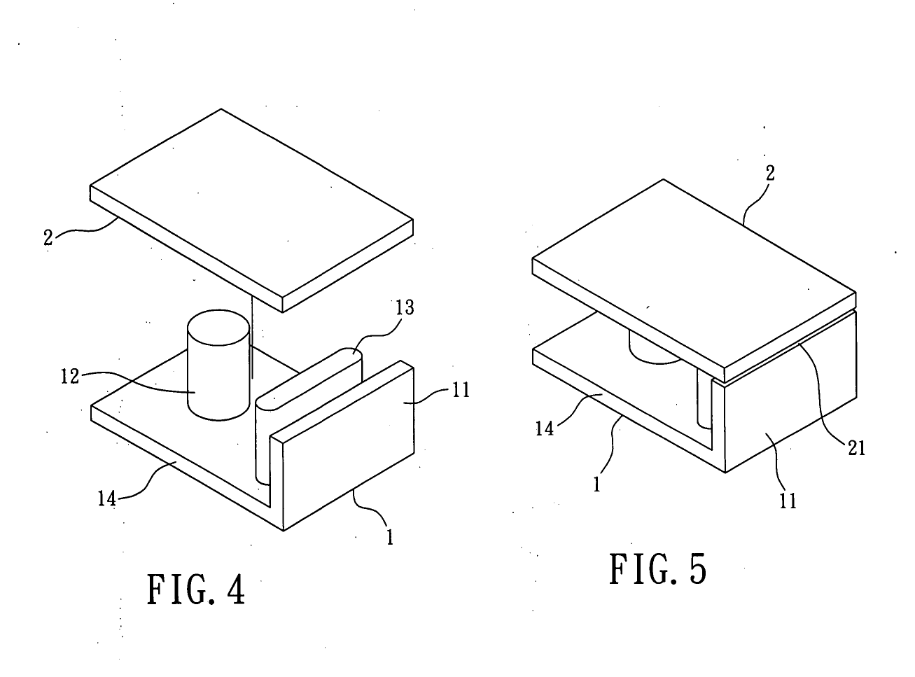

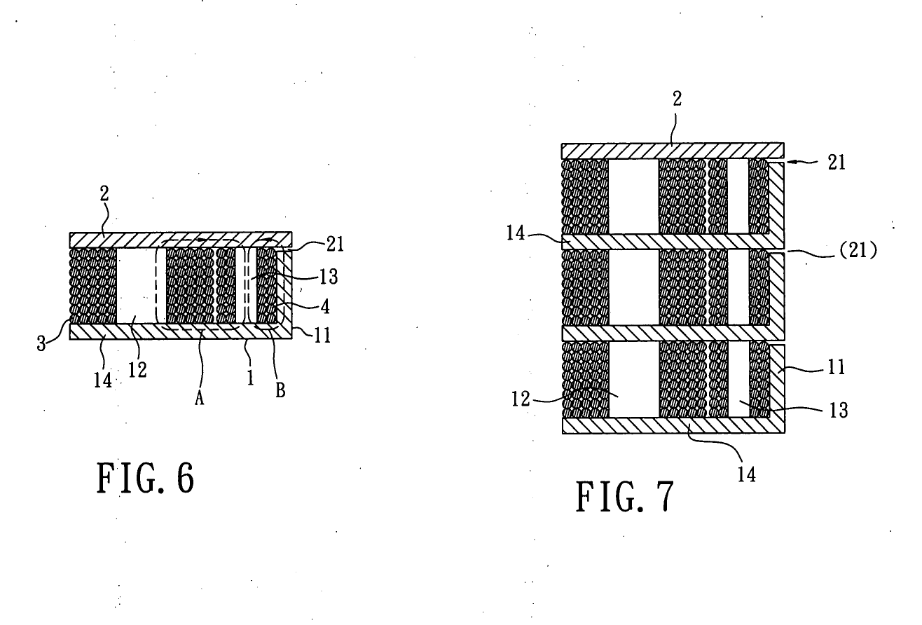

FIG. 4 is an exploded view of the core structure of the prior art while FIG. 5 is an isometric view showing the outward appearance of the assembled core structure of the invention. As shown in FIG. 4 and FIG. 5, the invention mainly includes a primary core (1), a secondary core (2), a primary coil (3), and a secondary coil (4) (see FIG. 6). The primary core (1) further include a first side (14) and a second side (11) where the second side (11) of the primary core (1) is connected, in perpendicular direction, to an end of the first side (14) of the primary core (1). Moreover, a first salient portion (12) and a second salient portion (13) being in the same height and both being relatively higher than that of the second side (11) are provided on the inner side of the first side (14) and are near and positioned outward from the second side (1 1). The primary coil (3) and the secondary coil (4) (see FIG. 6) wind respectively around the first salient portion (12) and the second salient portion (13) of the primary core (1). What is more, the secondary core (2) appearing a plate in shape can cover upon the top surfaces of the first salient portion (12) and the second salient portion (13) respectively, and has an end portion extending above the top of the second side (11) of the primary core (1) to form a gap (21) between them.

FIG. 6 is a schematic cross-sectional view of the magnetic flux circuit of the core structure of the invention. As shown in FIG. 6, once power is on for the primary coil (3) (or secondary coil (4)) having relatively lower voltage, a magnetic flux circuit A is formed between the primary core (1) and secondary core (2) at the first salient portion (12) and second salient portion (13). Moreover, an anti-magnetic flux circuit B is also formed between the primary core (1) and the secondary core (2) at the second salient portion (13) and the second side (11). In this way, the core structure of the invention can form a relatively higher induced voltage at the secondary coil (4) (or the primary coil (3)). In addition, the core structure of the invention can maintain a stable output current by making use of the anti-magnetic flux circuit B. In the meantime, by changing the size of the gap (21) between the second side (11) of the primary core (1) and the secondary core (2), one can adjust output current at the end of the relatively higher voltage. In other word, as the gap (21) becomes larger, the output current will be higher, and as the gap (21) becomes smaller, the output current will be lower. In this way, the fact that one can adjust within a small range to form a stable output current can make the electrically discharged light tube maintain in a status of optimum power supply.

FIG. 7 is a preferred derived embodiment of the invention. As shown in FIG. 7, in response to the various design requirements, the invention can greatly increase the rated value of output current by combining in parallel a plurality of unit structures of the primary core (1) and secondary core (2).

In accordance with the above-mentioned description, it is known that the improved structure of the high voltage stabilizer of the invention has the efficacies of low cost and maintaining stable output current through some adjustments.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. An improved structure of high voltage stabilizer comprising at least:
a primary core consisting of a first side and a second side that are perpendicular and connected each other; and a first salient portion and a second salient portion having the same height and both being relatively higher than that of the second side are provided on the inner side of the first side and are positioned in the middle section thereof;
a primary coil winding around the first salient portion of the primary core; and
a secondary coil winding around the second salient portion of the primary core;
a secondary core appearing a plate in shape and being capable of covering upon the top surfaces of the first salient portion and the second salient portion respectively and having an end portion extending above the top of the second side of the primary core to form a gap between the primary core and the secondary core.

2. The improved structure of high voltage stabilizer as claimed in claim 1, wherein a plurality of unit structures of the primary core and secondary core are combined in parallel to increase the rated value of output current.
